(19) United States
(12) Patent Application Publication
(10) Pub. No.: US 2005/0115636 A1
(43) Pub. Date: Jun. 2, 2005

(54) Head for a fuel tank filler neck

(75) Inventors: Cyrielle Cheng, Saint-Jean De Monts (FR); Pierre Milhas, Vitry-Le-Francois (FR); Sylvie Minguet-Barlerin, Vitry-Le-Francois (FR)

Correspondence Address: YOUNG & THOMPSON, 745 SOUTH 23RD STREET, 2ND FLOOR, ARLINGTON, VA, 22202, US

(73) Assignee: Nobel Plastiques, Marolles (FR)

(21) Appl. No.: 10/503,390

(22) PCT Filed: Jan. 31, 2003
(86) PCT No.: PCT/FR03/00297

(30) Foreign Application Priority Data
Feb. 4, 2002 (FR) 02/01268

(51) Int. Cl. B65B 1/04; B67C 3/00

(52) U.S. Cl. 141/301

(57) ABSTRACT

A head for a fuel tank filler tube includes a tubular body (3) having one end (5) for connection to the tube and an opposite end forming a filler orifice (6) via which a pump nozzle can be inserted into a filler duct, the body including a duct (14) for removing fuel vapor that is arranged to communicate firstly with the fuel tube and secondly with the outside of the tubular body via a vent (17) formed through a side wall (4) thereof, and a vent shutter (21) mounted in the body to be driven by the pump nozzle on being inserted into the filler duct from a vent shutting position towards a position in which the vent is disengaged.

The present invention relates to a head for a fuel tank filler tube of the kind fitted to motor vehicles driven by internal combustion engines.

### BACKGROUND OF THE INVENTION

As a general rule, a head for a filler tube comprises a tubular body which defines a filler duct and which has one end for connection to the tube and an opposite end that forms a filler orifice to enable the nozzle of a fuel pump to be inserted into the filler duct.

During filling, it is necessary to remove fuel vapor, firstly to limit the amount that escapes into the atmosphere, and secondly to ensure that the vapor does not lead to pressure rising in the filler tube. Such an increase in pressure would run the risk of triggering the pump nozzle too soon, thereby stopping the delivery of fuel before the tank is, in fact, full.

A system for removing fuel vapor and delivering it to a unit for treating such vapor (known as a canister) is therefore associated with the tank. A pipe connects the tank to the canister. A first segment of the pipe extends parallel to the filler tube as far as a check valve device from which a second segment of the pipe goes to the canister. The check valve device is mounted on the head of the filler tube and the check valve is connected either to the hatch giving access to the filler orifice and for handling by the user, or else to a pivoting flap for closing the filler duct and designed to be pushed aside by the nozzle when it is inserted into the filler duct, so as to be moved from a closed position to an open position during filling.

Those systems present the drawback of being relatively heavy, bulky, complex with numerous parts, and expensive to manufacture.

### BRIEF SUMMARY OF THE INVENTION

The invention provides a head for a fuel tank filler tube, the head comprising a tubular body having one end for connection to the tube and an opposite end forming a filler orifice enabling a fuel pump nozzle to be introduced into a first end of a filler duct which is defined by the body and which possesses an opposite, second end for opening out into the filler tube via the connection end of the body, the body incorporating a segment of fuel vapor removal duct arranged to communicate firstly with the outside of the body via a vent which is provided through a side wall of the body and which is associated with vent shutter means mounted in the body to be actuatable between a vent shutting position and a vent disengaging position and, secondly, at least during filling, with the filler tube at the connection end of the body.

Thus, the segment of removal duct associated with the filler tube head is incorporated in the body thereof and opens out into the filler tube which is also used as a segment of the duct for removing fuel vapor. The structure of the filler tube head is then particularly simple, compact, light in weight, and the number of parts used for removing vapor is small. Manufacturing costs and time (in particular assembly time) are relatively small.

In a particular embodiment, the vent shutter means comprises a shutter element connected to a bushing mounted in the body in the vicinity of the first end of the filler duct to be driven by the pump nozzle in sliding movement from a first position in which the shutter element closes the vent towards a second position in which the shutter element is disengaged from the vent.

The shutter means are thus actuated automatically during filling.

Preferably, the bushing comprises a first end portion mounted in the first end of the filler duct, and an opposite second end portion which projects from the first end of the filler duct and which is connected to the shutter element by an arm extending axially inside the body outside the filler duct.

The shutter means are thus simple in structure.

Advantageously, the first end portion of the bushing includes an end wall that is convex towards the inside of the bushing, and is provided in its side wall with at least one slot in the vicinity of said end wall for passing fuel and, preferably, the filler duct includes an enlarged segment extending facing the second end portion of the bushing when the bushing is in its second position.

This improves the flow of fuel.

According to a particular characteristic, the removal pipe is annular in shape and surrounds the filler duct.

The filler tube head is then particularly compact.

Other characteristics and advantages of the invention will appear on reading the following description of a particular, non-limiting embodiment of the invention.

### BRIEF DESCRIPTION OF THE DRAWINGS

Reference is made to the accompanying drawings, in which:

FIG. 1 is a diagrammatic exploded view in perspective of the filler tube head in accordance with the invention; and

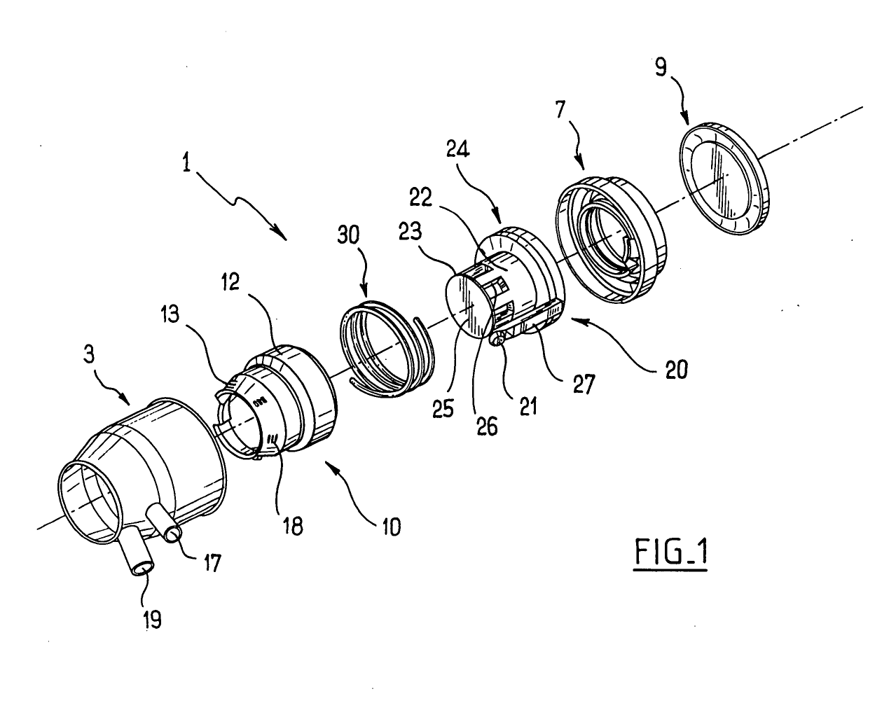

FIG. 2 is a diagrammatic longitudinal section view of said filler tube head.

### DETAILED DESCRIPTION OF THE INVENTION

The invention as shown in the figures relates to a head given overall reference 1 for a filler tube 2 of a fuel tank (not shown). By way of example, the fuel tank belongs to a motor vehicle having the filler tube 2 disposed in its bodywork in such a manner that the head 1 opens to the outside of the bodywork. By way of example, the head 1 is mounted in a setback formed in the bodywork and closed by a hatch that is accessible from the outside.

The head 1 comprises a tubular body given overall reference 3, being defined by a substantially cylindrical wall 4 having one end 5 bonded to the filler tube 2, and an opposite end 6 on which there is mounted an annular sealing element 7 defining a filler orifice 8 associated with a filler cap 9. The annular sealing element 7 is made of a flexible material and is intended to form an abutment against the fuel pump nozzle being pushed further into the body 3 through the filler orifice 8, while nevertheless providing leaktight contact with the nozzle.

A sleeve 10 is mounted in the body 3 and defines a filler duct 11. The sleeve 10 possesses an end 12 facing the filler orifice 8 to enable the pump nozzle to be inserted through the orifice into the filler duct 11, and an opposite end 13 that opens out into the filler tube 2 at the end 5 of the body 3.

The portion of the sleeve 10 that is adjacent to the end 13 co-operates with the wall 4 of the body 3 to define a segment of removal duct 14 for removing fuel vapor. The removal duct segment 14 is annular in shape and possesses a bottom portion 15 in communication with the filler tube 2 via the end 5 of the wall 4, and a top portion 16 in communication with the outside of the body 3 via a vent 17 which is formed through the wall 4 thereof.

The end 13 of the sleeve 10 is provided on the outside with fins 18 projecting into the removal duct segment 14 to form means for condensing fuel vapor.

The body 3 has an overflow orifice 19 formed in the wall 4 near the end 5 thereof. The overflow orifice 19 is for connection to the tank via a pipe (not shown) returning to the tank.

The body 3 includes means given overall reference 20 for shutting the vent 17, said means being mounted in the body 3 to be actuatable between a position for closing the vent 17 and a position for disengaging the vent 17.

The shutter means 20 comprise a shutter element 21 connected to a bushing 22 which has an end portion 23 slidably mounted in the end 12 of the sleeve 10 opposite from an end portion 24 that projects from the end 12 of the sleeve 10.

The end portion 23 of the bushing 22 includes an end wall 25 that is convex towards the inside of the bushing (in this case the end wall is conical in shape) and that is provided in its side wall with slots 26 in the vicinity of the end wall 25 to allow fuel to flow through.

The end portion 24 is connected to the shutter element 21 by an arm 27 extending axially in the body 3 between the wall 4 and the sleeve 10. In this case, the shutter element 21 is formed by an outwardly-projecting stud at the free end of the arm 27 extending towards the wall 4. The annular sealing element 7 is connected to the end portion 24 via the edge of the filler orifice 8.

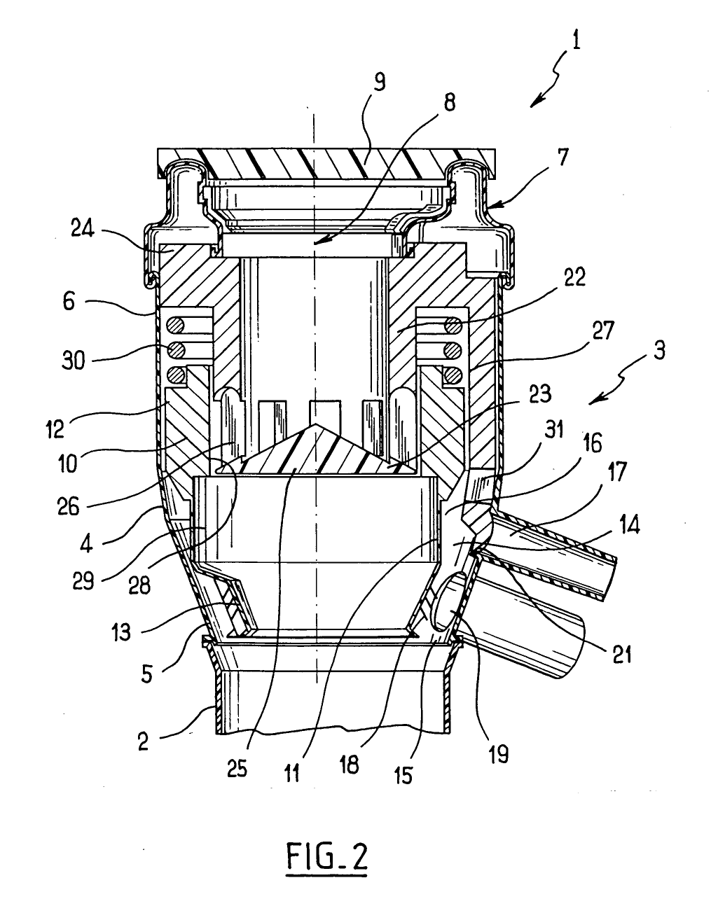

The bushing 22 is movable between a first position shown in FIG. 2 in which the shutter element 21 closes the vent 17 and the slots 26 face a segment 28 of the sleeve 10 of inside diameter substantially equal to the outside diameter of the end portion 23, and a second position in which the bushing is pushed in, and in which the shutter element 21 is disengaged from the vent 17 and the slots 26 look into an enlarged segment 29 of the sleeve 10.

Resilient return means 30 urge the bushing 22 towards its first position, said means being interposed between a collar on the end portion 24 of the bushing 22 and the end 12 of the sleeve 10. In this case, the means 30 are constituted by a helical compression spring.

In the normal position, while filling is not taking place, the bushing 22 is in its first position. Fuel vapor rising from the tank via the filler tube 2 condenses on making contact with the fins 18 and drops back in the form of droplets into the tank.

During filling, the fuel pump nozzle is inserted through the filler orifice 8 into the end portion 23 of the bushing 22 until a portion of the nozzle comes into abutment against the annular sealing element 7 and deforms it. The bushing 22 is then driven by the leading end of the nozzle to slide from its first position in which the shutter element 21 closes off the vent 17 towards its second position in which the shutter element 21 is disengaged from the vent 17.

The fuel which flows from the pump nozzle is directed by the end wall 25 towards the slots 26 so as to spread out in the enlarged segment 29 prior to flowing into the tube 2. It should be observed that the flow section for the fuel at the end 13 of the sleeve 10 is smaller than the section of the tube 2.

Fuel vapor rises via the tube 2 towards the removal duct segment 14 and escapes via the vent 17 towards a canister (not shown). In order to improve the passage of vapor into the vent 17, an opening 31 is provided in the arm 27, which opening is designed to be level with the vent 17 when the bushing is in its second position.

If too much fuel is delivered before the nozzle triggers automatically, the excess fuel overflows towards the return pipe to the tank via the overflow orifice 19.

After the pump nozzle has been withdrawn, the bushing 22 returns to its first position under drive from the resilient return means 30. It should be observed that in this position the slots 26 are closed by the wall of the segment 28.

Naturally, the invention is not limited to the embodiment described but also covers any embodiment and variant that reproduces the subject matter of the claims.

In particular, the wall 4 and the sleeve 10 may be made as a single piece; the means for actuating the shutter element to the cap 9, to a pivoting shutter flap or to the access hatch to the filler head; the sleeve may have other forms.

1. A head for a fuel tank filler tube, the head comprising a tubular body (3) having one end (5) for connection to the tube and an opposite end forming a filler orifice (6) enabling a fuel pump nozzle to be introduced into a first end (12) of a filler duct (11) which is defined by the body and which possesses an opposite, second end (13) for opening out into the filler tube via the connection end of the body, the body incorporating a segment (14) of fuel vapor removal duct arranged to communicate with the outside of the body via a vent (17) which is provided through a side wall (4) of the body and which is associated with shutter means (21) mounted in the body to be actuatable between a vent shutting position and a vent disengaging position, wherein the removal duct segment (14) is also arranged to communicate, at least during filling, with the filler tube via the connection end of the body.

2. A filler tube head according to claim 1, wherein the vent shutter means (17) comprises a shutter element (22) connected to a bushing (22) mounted in the body (8) in the vicinity of the first end (12) of the filler duct (11) to be driven by the pump nozzle in sliding movement from a first position in which the shutter element closes the vent towards a second position in which the shutter element is disengaged from the vent.

3. A filler tube head according to claim 2, wherein the bushing (22) comprises a first end portion (23) mounted in the first end (12) of the filler duct (11), and an opposite second end portion (24) which projects from the first end (12) of the filler duct (11) and which is connected to the shutter element (21) by an arm (27) extending axially inside the body (3) outside the filler duct.

4. A filler tube head according to claim 3, wherein the first end portion (23) of the bushing (22) includes an end wall (25) that is convex towards the inside of the bushing, and is provided in its side wall with at least one slot (26) in the vicinity of said end wall for passing fuel.

5. A filler tube head according to claim 4, wherein the filler duct (11) includes an enlarged segment (29) extending facing the second end portion (23) of the bushing (22) when the bushing is in its second position.

6. A filler tube head according to claim 2, wherein the body (3) includes means (30) for resiliently returning the bushing (22) into its first position.

7. A filler tube head according to claim 1, wherein the removal duct segment (14) is annular in shape and surrounds the filler duct (11).

8. A filler tube head according to claim 7, wherein the second end (13) of the filler duct (11) is provided on the outside with at least one fin (18) extending into the removal duct segment (14) to form means for condensing fuel vapor.

9. A filler tube head according to claim 1, wherein the body (3) includes an overflow orifice (19) disposed in the vicinity of the connection end (15).
